(19) United States
(12) Patent Application Publication
(10) Pub. No.: US 2002/0005438 A1
(43) Pub. Date: Jan. 17, 2002

(54) Method and apparatus for controlling the emptying of a induction unit of an agricultural sprayer

(75) Inventor: Alain Guesdon, Noisy Sur Ecole (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KUHN-NODET S.A., MONTEREAU (FR)

(21) Appl. No.: 09/899,154

(22) Filed: Jul. 6, 2001

(30) Foreign Application Priority Data
Jul. 13, 2000 (FR) 00 09177

(51) Int. Cl. B05B 9/03; B05B 9/00

(52) U.S. Cl. 239/156; 239/172; 239/146; 239/147; 239/155; 239/157

(57) ABSTRACT

A method for driving the emptying of an induction unit with which an agricultural sprayer is equipped. The emptying is driven by a user acting with at least one of his lower limbs on a drive element. An agricultural sprayer for implementing such a method, comprising a drive element which has just one stable position.

### BACKGROUND OF THE INVENTION

1. Field of the Invention

The present invention relates to the technical field of agricultural sprayers, and relates more particularly to the drive of the emptying of an induction unit with which such a machine is equipped.

Agricultural sprayers are used for spreading a treatment spray mix in the form of droplets onto plants. For this purpose they comprise various elements connected to one another by a water circuit. These elements are, in particular, a main tank containing the spray mix and spray nozzles intended to spread said spray mix over the plants that are to be treated. Spraying therefore consist in pumping the spray mix, using the water circuit, from the main tank to the nozzles, these nozzles being passed over the plants that are to be treated.

Before actually carrying out the spraying, the user has, among other things, to prepare the treatment spray mix. Now, for obvious storage reasons, the active compound of the spray mix is generally packaged in the form of concentrate in cans. Preparing the spray mix therefore consists in diluting one or more active compounds, for example plant protection products, in water. To do this, and for user-safety reasons, most agricultural sprayers also comprise an induction unit. This may be fixed or movable with respect to the sprayer, but is preferably accessible from the ground. The induction unit is made up of a tub into which the user tips the cans of active compound. When preparing the spray mix, the tub is emptied into the main tank via the water circuit.

2. Discussion of the Background

In agricultural sprayers currently present on the market, particularly the sprayer described in patent application FR 2 714 572, the induction unit is emptied by means of a drain valve driven by a hand grip. When preparing the spray mix, the user turns this grip in order to open the drain valve and thus transfer the active compound contained in the tub to the main tank. Said drain valve and the grip are generally arranged under the induction unit. Now, the induction unit is relatively close to the ground to make the operations of tipping out the contents of the cans easier. In consequence the user has to stoop in order to reach said grip with his hand. This action is already painful in itself, and also has the drawback of bringing the user's face close to the active compound contained in the induction unit. This proximity considerably increases the risk of accidents since the plant protection products, for example, are generally corrosive: any splashing may therefore cause burning of the skin and lesions in the eyes. In addition, with this type of hand grip drive currently used in agricultural sprayers, there is a risk that the drain valve will remain open, as the result of user oversight, after the spray mix has been prepared. During spraying, for example, such a situation may lead to the spray mix being transferred back to the induction unit, and may thus lead to a loss of the content of the main tank.

### SUMMARY OF THE INVENTION

The object of the present invention is therefore aimed at overcoming the various drawbacks of the state of the art by proposing a method for driving the emptying of the induction unit which makes preparing the spray mix easier while at the same time reducing the risks of accidents.

To this end, said method for driving the emptying of an induction unit is characterized in that the user drives said emptying by acting, with at least one of his lower limbs, on a drive element. The user may thus, on one hand, use both hands for handling the cans and, on another hand, keep his face away from the dangerous products.

In addition, the present invention also relates to an agricultural sprayer for implementing this drive method. Said sprayer therefore comprises a drive element and said emptying of the induction unit occurs by means of a valve. According to another feature of the present invention, when the user is no longer acting on the drive element, said valve closes again automatically and this isolates said induction unit from the water circuit. In consequence, there is no risk of the contents of the main tank escaping as a result of oversight on the part of the user, through the induction unit.

### BRIEF DESCRIPTION OF THE DRAWINGS

Other features of the invention will also become apparent from the other subclaims and from the following description of one nonlimiting exemplary embodiment of the invention which is depicted in the appended drawings, in which:

FIG. 1 depicts, in a side view and during transport, an agricultural sprayer according to the invention,

FIG. 2 depicts, viewed in the direction of the arrow I defined in FIG. 1, an induction unit according to the invention in the transport position,

FIG. 3 depicts, also viewed in the direction of the arrow I, the induction unit of FIG. 2 in the filling position.

### DESCRIPTION OF THE PREFERRED EMBODIMENTS

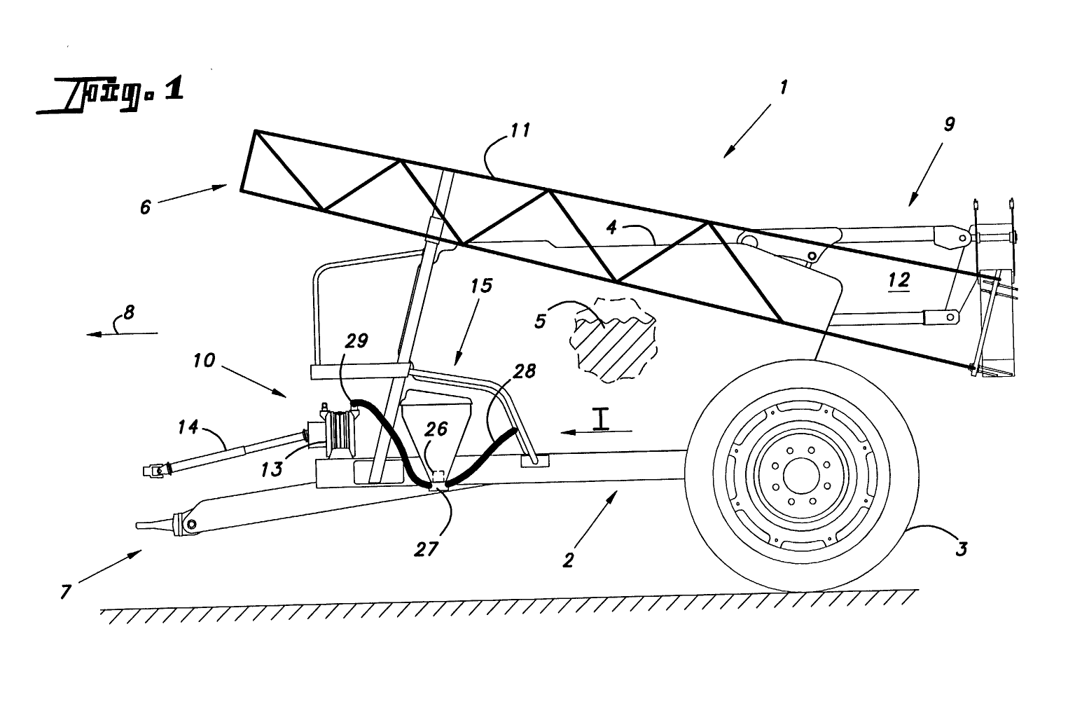

FIG. 1 depicts an agricultural sprayer 1 according to the invention, in the transport position. Said sprayer 1 comprises a chassis 2 which runs along the ground by means of two wheels 3. Said chassis 2 supports, on one hand, a main tank 4 containing a treatment spray mix 5 and, on another hand, several spray nozzles (not depicted) arranged at substantially regular intervals along a spreading boom 6. Said chassis 2 is connected, in a known way, to a motor vehicle (not depicted) by means of a draw bar 7. Said motor vehicle trails said sprayer 1 in a direction of travel 8. In this embodiment, said sprayer 1 is therefore of the trailed type. It goes without saying that the present invention also relates to sprayers of the mounted type and to self-propelled sprayers.

During work, said agricultural sprayer 1 is moved in said direction of travel 8 across a field containing plants to be treated. Said spreader boom 6 is arranged transversely to said direction of travel 8 on each side of a vertical midplane of said sprayer 1. For its part, said treatment spray mix 5 is pumped from the main tank 4 to be deposited, by virtue of said spray nozzles, in the form of droplets on said plants.

To do this, said spreading boom 6 is connected to said chassis 2 by means of a connecting device 9, and said main tank 4 is connected to said nozzles by means of a water circuit 10 (depicted partially). Said spreader boom 6 comprises, in the known way, a latticework structure 11, the lower part of which supports said nozzles. Said latticework structure 11 is advantageously cut in sections which are articulated to one another. Thus, for transport, said boom 6 can be folded several times to reduce the overall width of said sprayer 1.

In order to adapt the spraying height of said nozzles to suit the height of the plants that are to be treated, said connecting device 9 allows said spreading boom 6 to be moved with respect to said chassis 2 in a substantially vertical direction. To do this, said connecting device 9 consists, in this exemplary embodiment, of a single deformable quadrilateral 12 which extends at substantially in said vertical midplane. For further details about said connecting device 9, those skilled in the art may refer to the French patent application registered under the number 00/03454.

For its part, said water circuit 10 comprises at least one pump 13 driven, in the exemplary embodiment depicted in FIG. 1, off the power take-off of the motor vehicle by means of a universally-jointed transmission shaft 14. In order to connect said main tank 4 to said spray nozzles, said water circuit 10 also comprises several pipes and valves.

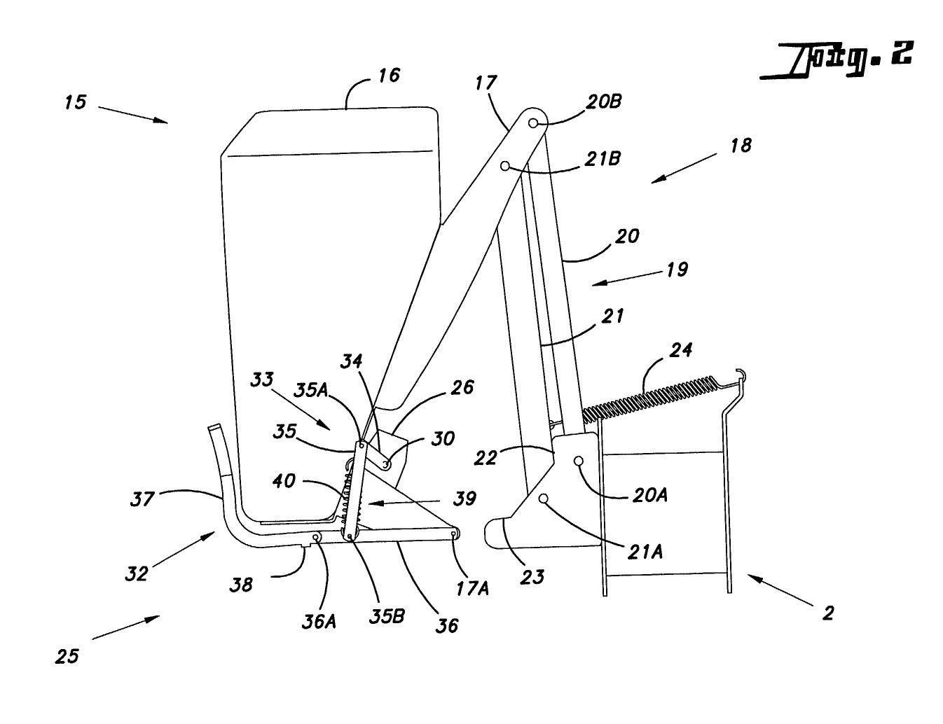

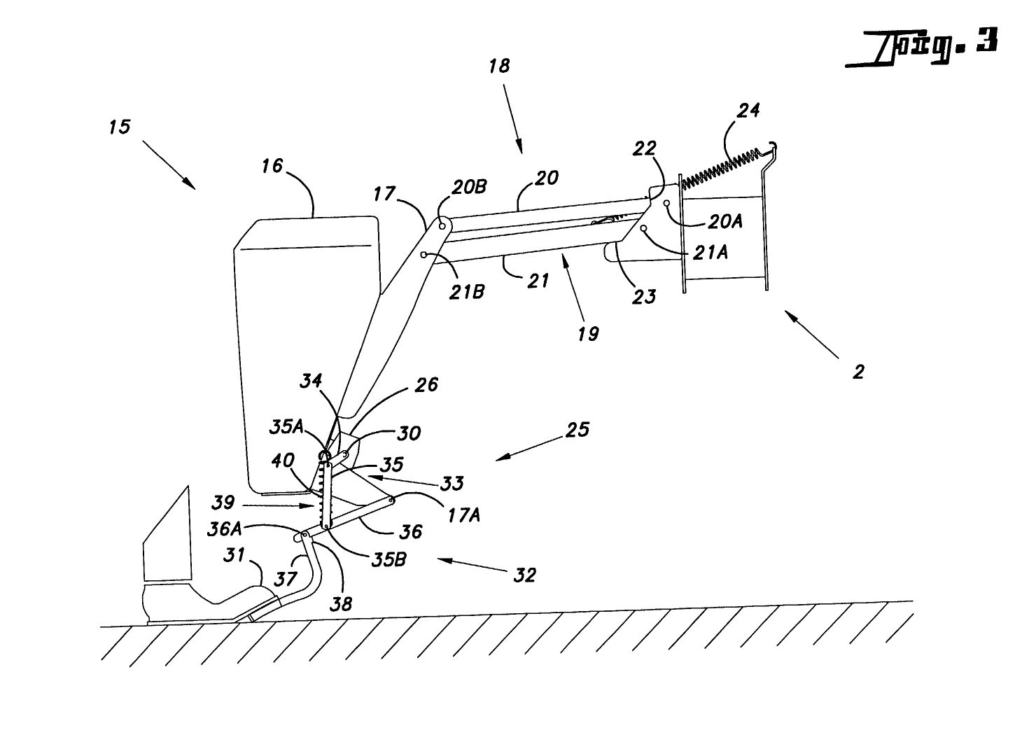

Said treatment spray mix 5 is generally obtained by diluting an active compound, for example a plant protection product, in water. To do this, said agricultural sprayer 1 according to the invention additionally comprises, in a way known to those skilled in the art, an induction unit 15 intended to receive said active compound. Said induction unit 15 can advantageously move with respect to said sprayer 1. It can thus occupy a transport position (FIGS. 1 and 2) or a filling position (FIG. 3). For this purpose and referring to FIGS. 2 and 3, said induction unit 15 comprises a tub 16 supported by a framework 17. For its part, said framework 17 is connected to said chassis 2 by means of an articulated arm 18.

In the exemplary embodiment depicted in FIGS. 2 and 3, said articulated arm 18 is produced in the form of a parallelogram 19 made up of an upper rod 20 and of a lower rod 21. Said rods 20, 21 are connected, on one hand, to said chassis 2 by means of a respective articulation 20A, 21A and, on another hand, to said framework 17 by means of a respective articulation 20B, 21B. Said articulations 20A, 21A, 20B, 21B are advantageously of the pivot type, the respective axes of which are substantially mutually parallel. Said parallelogram 19 extends in a plane of extension that is substantially vertical, and the angular travel of the lower rod 21 about the articulation 21A is delimited by two stops 22, 23.

Said articulated arm 18 advantageously also comprises a tension spring 24 connected, on one hand, to said chassis 2 and, on another hand, to said lower rod 21. Said tension spring 24 makes it possible, on one hand, to keep said induction unit in the transport position by pressing said lower rod 21 against the upper stop 22. On another hand, said tension spring 24 also makes said induction unit 15 easier to move from the filling position to the transport position by taking at least part of the weight of said induction unit 15. However, the anchoring points of said tension spring 24 are advantageously determined so that in the filling position said lower rod 21 rests against the lower stop 23 in spite of the force exerted by the tension spring 24. Said induction unit 15 can thus easily be translated from a transport position which, amongst other things, makes the spraying operations easier (FIG. 2) to a filling operation making access to said tub 16 easier (FIG. 3), and vice versa.

When preparing said treatment spray mix 5, said tub 16 is intended to receive the active compound, which is generally stored in the form of concentrate in cans. To do this, the user pulls said induction unit 15 toward himself so as to lower the latter into the filling position, and he empties said cans into said tub 16. Said active compound is then diluted by emptying said tub 16 into said main tank 4 via the water circuit 10. Finally, the user pushes said induction unit 15 back toward said chassis 2 so that the latter can be raised back into the transport position. In another exemplary embodiment which has not been depicted, said induction unit 15 additionally comprises a device allowing said cans and said tub 16 to be rinsed out after use.

According to one feature of the present invention, the user drives the emptying of said induction unit 15 by acting with at least one of his lower limbs on a drive element 25. By acting in this way, the user advantageously keeps use of both hands for handling said cans, hence reducing the risk of accident. To this end in the exemplary embodiment depicted in the figures, said drive element 25 acts on a drain valve 26 which connects said induction unit 15 to said water circuit 10. More specifically in the light of FIG. 1, said drain valve 26 is connected between the bottom of said tub 16 and the intake orifice of an injector 27. Said injector 27 is inserted in a pipe 28 which connects the delivery orifice 29 of said pump 13 to said main tank 4. In a way known to those skilled in the art, said drain valve 26 comprises a drive axle 30, the rotation of which determines the opening or closing of said valve 26. In the exemplary embodiment depicted more specifically in FIGS. 2 and 3, the user drives the emptying of said induction unit 15 by acting with one of his feet 31. Thus, said drive element 25 comprises a pedal 32 actuated by said foot 31 of the user, and a transmission mechanism 33 connecting said pedal 32 to said drive axle 30. In another exemplary embodiment which has not been depicted, the user drives said emptying by acting with both feet 31 on a drive element 25.

During transport or spraying, said induction unit 15 and its auxiliary elements such as the drive element 25 for example must not impede the correct operation of the latter. On another hand, when preparing said treatment spray mix 5, it goes without saying that the user has to be able to access said drive element 25 very easily. For this reason, in the exemplary embodiment depicted in FIGS. 2 and 3, the drive element 25 is connected to said induction unit 15 and located as close as possible thereto. More specifically, said pedal 32 is on one hand connected to said framework 17 by means of an articulation 17A and on another hand is advantageously located under said induction unit 15. Thus, when the latter is lowered into the filling position, said pedal 32 is relatively close to the ground and therefore very easy for said user to access with one foot 31. In addition, said pedal 32 is advantageously made up of a connecting element 36 and of a retractable contact element 37 which are connected together by means of an articulation 36A. Said contact element 37 is intended to take said foot 31, and said connecting element 36 is connected to said framework 17 by means of said articulation 17A. Said contact element 37 can occupy a transport position as visible in FIG. 2 where it conforms as closely as possible to the shape of said tub 16. It may also occupy a service position, as visible in FIG. 3, in which it is easily accessible to said foot 31.

Prior to use, the user moves said contact element 37 away from said tub 16 by pivoting it, by about 90 degrees downward, with respect to said connecting element 36 about said articulation 36A. By acting in this way, said contact element 37 is once again brought closer to the ground and therefore made even easier to access. The rotation of said contact element 37 with respect to said connecting element 36 about said articulation 36A is limited by means of a stop 38. Once in the service position, any downward force applied to said contact element 37 therefore this time causes the entirety of said pedal 32 to rotate about the articulation 17A and therefore operates said drain valve 26.

After service, the user this time brings said contact element 37 closer to said tub 16 by pivoting it, by about 90 degrees upward, with respect to said connecting element 36 about said articulation 36A. The rotation of said contact element 37 with respect to said connecting element 36 about said articulation 36A is advantageously limited, in this direction also, by means of the same stop 38. Said contact element 37 is kept in the transport position or in the service position by any means known to those skilled in the art, for example a tension spring.

In order to simplify said transmission mechanism 33, said drain valve 26 is also connected to said induction unit 15 in the immediate vicinity of said pedal 32. As a result of this, said transmission mechanism 33 comprises a first link 34 connected, on one hand, to said drive axle 30 and, on another hand, to one end of a second link 35 by means of a first articulation 35A. The second end of said second link 35 is, for its part, connected to said connecting element 36 by means of a second articulation 35B. Said articulations 17A, 35A, 35B are advantageously of the pivot type, the respective axes of which are substantially parallel to the drive axle 30. Thus, the action of said foot 31 of the user on said pedal 32 is converted into a rotation of said drive axle 30 of said drain valve 26.

According to another feature of the present invention, the emptying of said induction unit 15 is interrupted automatically when said user stops acting on the drive element 25. To this end, in the exemplary embodiment depicted, a return means 39 is provided which causes said drain valve 26 to close when said drive element 25 is no longer acted upon. More specifically, in the light of FIGS. 2 and 3, said return means 39 is made up of a release spring 40 connected, on one hand, to said pedal 32 and, on another hand, to said framework 17. When the user removes his foot 31 from said pedal 32, said return means 39 tends to return this pedal to its initial position and thus, via said transmission mechanism 33, tends to close said drain valve 26 again. Thus, when the preparation of the spray mix 5 is complete, said induction unit 15 is automatically isolated from said water circuit 10.

The method for driving the emptying of said induction unit 15 and the agricultural sprayer 1 which have just been described, are merely examples which must not in any way be taken to limit the field of protection defined by the claims which follow.

Specifically, said driving method may perfectly well be applied to other means of emptying said induction unit 15, for example a pump or other types of valve, operated electrically or pneumatically. Likewise, the present invention also relates to agricultural sprayers 1 in which the induction unit 15 is fixed.

What is claimed as new and desired to be secured by Letters Patent of the United States is:

1. Method for driving an emptying of an induction unit with which an agricultural sprayer is equipped, wherein said emptying is driven by a user acting with a lower limb on a drive element.

2. Method as claimed in claim 1, comprising the step of emptying said induction unit when said user acts on said drive element.

3. Method as claimed in claim 1, comprising the step of stopping the emptying of said induction unit when said user stops acting on the drive element.

4. Method as claimed in claim 1, comprising the steps of:
emptying said induction unit when said user acts on said drive element;
stopping the emptying of said induction unit when said user stops acting on the drive element.

5. Agricultural sprayer comprising an induction unit connected to a water circuit by means of a drain valve operated by a drive element, wherein said drive element has just one stable position.

6. Agricultural sprayer as claimed in claim 5, wherein when the drive element is acted upon, said drain valve is opened.

7. Agricultural sprayer as claimed in claim 5, wherein when the drive element is not acted upon, said drain valve is automatically closed.

8. Agricultural sprayer as claimed in claim 5, wherein the drive element is connected to said induction unit.

9. Agricultural sprayer as claimed in claim 5, wherein the drive element is arranged under said induction unit.

10. Agricultural sprayer as claimed in claim 5, wherein said drive element is connected to said drain valve by means of a transmission mechanism comprising links.

11. Agricultural sprayer as claimed in claim 5, wherein said drive element is kept in said stable position by a release means.

12. Agricultural sprayer as claimed in claim 5, wherein said drive element is a pedal.

13. Agricultural sprayer as claimed in claim 12, wherein said pedal has a connecting element and a contact element.

14. Agricultural sprayer as claimed in claim 13, wherein said contact element can occupy a transport position and a service position.

15. Agricultural sprayer as claimed in claim 5, wherein said induction unit is mobile.

16. Agricultural sprayer as claimed in claim 5, wherein said drain valve is connected to said induction unit in an immediate vicinity of said drive element.
